(19) United States
(12) Patent Application Publication
(10) Pub. No.: US 2007/0160414 A1
(43) Pub. Date: Jul. 12, 2007

(54) Binding system for binding sheet material

(76) Inventor: Bernd Loibl, Klettgau (DE)

Correspondence Address: BERENATO, WHITE & STAVISH, LLC, 6550 ROCK SPRING DRIVE, SUITE 240, BETHESDA, MD, 20817, US

(21) Appl. No.: 11/648,902

(22) Filed: Jan. 3, 2007

(30) Foreign Application Priority Data
Jan. 3, 2006 (DE) 20 2006 000 083.6

(51) Int. Cl. B42F 13/02

(52) U.S. Cl. 402/8

(57) ABSTRACT

binding system for binding sheet material equipped with a perforation is disclosed. The system comprises a binding ring that can be brought from an open state, in which it forms a gap for placing the sheet material onto the binding ring into a closed state, in which the binding ring does not form a gap. The binding ring is embodied as an individual ring having no connection to a binding spine.

### CROSS-REFERENCE TO RELATED APPLICATIONS AND CLAIM TO PRIORITY

This application is related to utility model application no. 20 2006 000 083.6, filed Jan. 3, 2006 in the Federal Republic of Germany, the disclosure of which is incorporated herein by reference and to which priority is claimed.

### FIELD OF THE INVENTION

The present invention relates to a binding system for binding sheet material equipped with a perforation, the binding system comprising a binding ring that can be brought from an open state, in which it forms a gap for placing the sheet material onto the binding ring, into a closed state, in which the binding ring does not form a gap.

### BACKGROUND OF THE INVENTION

For binding a stack of sheet material made up, for example, of sheets of paper, it is known to perforate them and then place them onto a binding system. A plurality of binding systems of different kinds exist. A feature common to all of them is that binding fingers that are connected to one another are placed through the perforation. The spacing of the binding fingers then corresponds to the spacing of the individual holes of the perforation.

DE 103 93 593 T5 and WO 99/14059 disclose binding systems of the species in which a respective binding ring made up of two ring segments is mounted at specific spacings on a binding spine. The ring segments are movable from an open state, in which they respectively form a gap for placing the sheet material onto the binding ring, into a closed state, in which they form a closed ring. The movability of the ring segments is ensured by hinges.

The known binding systems have the disadvantage that the number and spacing of the binding rings must match the number and spacing of the holes of the perforation in the sheet material so that binding of the sheet material is possible. In addition, hinges tend to experience fatigue and break.

### SUMMARY OF THE INVENTION

It is the object of the present invention to configure a binding system of the kind cited above in such a way that sheet material can be bound in independently of how the perforation is constituted, in particular of the number and spacing of the holes.

This object is achieved, according to the present invention, in that the binding ring is embodied as an individual ring having no connection to a binding spine. The basic idea of the invention is therefore to dispense with a binding spine and to make available only at least one binding ring, onto which the sheet material can be placed when the binding ring is in an open state. Instead of a single binding ring, the binding system can also comprise multiple such binding rings that are then not connected to one another. A binding system of this kind is not only inexpensive but also universally applicable. The binding rings furthermore allow the sheet material to be opened out, at any point, sufficiently far that the pages which are open lie parallel to one another and are not curved. In addition, the pages can be turned over through an angle of 360°. The binding system is accordingly also well suited for demonstration purposes.

It is understood that by way of the size of the binding ring or rings, the maximum number of sheets that can be bound in therewith can be determined; in other words even very thick sheet stacks can be bound in by making the binding ring or rings correspondingly large. The cross section of the respective binding ring can correspondingly be precisely adapted to the cross section of the holes, so that the individual sheets of the sheet material can shift very little with respect to one another when at least two binding rings are used.

Gap formation can be achieved in various ways in the binding ring according to the present invention. For example, the binding ring as a whole can be embodied so flexibly that it can be bent open from the closed state into the open state for the placement of sheet material, no hinge being present. As an alternative thereto, provision can be made for the binding ring to comprise a hinge with which it is divided into ring segments that are pivotable relative to one another, via the hinge, in order to open and close the binding ring. In both cases it is advantageous if the binding ring(s) comprise(s) in the region of the gap at least one coupling element that brings about an overlap in the closed state. The overlap should then be constituted in such a way that the free ends of the binding ring cannot shift laterally with respect to one another. In addition, retainers can also be provided, for example in the form of snap-locks, which at least prevent spontaneous opening of the binding ring or even permit opening only by destroying the binding ring.

As an alternative to the embodiment described above, provision can also be made for each binding ring to comprise a sub-ring forming the gap, and a bridging element capable of closing the gap. With this embodiment the binding ring attains a closed state by the fact that the gap between the free ends of the sub-ring is closed by a respective bridging element. A binding ring of this kind has the advantage that it requires no hinge to produce the open state, and also need not be embodied sufficiently elastically that it can be bent open. The sub-ring and the bridging element can therefore be embodied rigidly, so that larger quantities of sheet material can also be securely bound in.

The above-described binding ring can be part of a binding system in which multiple such binding rings are connected to one another via a binding spine. Preferably, however, the binding ring should be embodied as an individual ring with no connection to a binding spine; here again, multiple such binding rings—which, as individual rings, are not connected to one another—can be provided.

The respective bridging element can be present in the unassembled state as a loose part, i.e. it is then not connected to the associated sub-ring. This does not preclude connecting it to the sub-ring via a hinge that permits a pivoting of the bridging elements into or out of the gap.

In a further embodiment of the invention, provision is made that the bridging element(s) comprise(s) a respective bridging piece that is adapted to the contour of the sub-ring in such a way that it fills up the gap in flush fashion and continues the contour of the sub-ring to yield a closed binding ring. The purpose of this feature is to obtain, after insertion of the bridging elements, a binding ring that exhibits no external discontinuities, for example projecting edges, changes in cross section, etc. This prevents the binding ring from catching in the perforation of the sheet material.

Provision is further made, according to the present invention, that the bridging element(s) comprise(s) at least one respective coupling tab, and that for each coupling tab, a recess for reception of the coupling tab is shaped into the respective sub-ring, in each case adjacent to the gap. The respective bridging element should preferably comprise coupling tabs on either side of the bridging piece, and recesses for overlapping reception of the coupling tabs should be shaped into the sub-ring on either side of the gap. There are numerous possibilities regarding details of the embodiment of the coupling tabs.

Connection of the coupling tab(s) to the associated sub-ring can be accomplished in various ways. An immovable connection can be achieved by the fact that the coupling tab is connectable via a respective snap-lock connection to the associated sub-ring; depending on the purpose, the snap-lock connection can be embodied in such a way that the bridging element can also be removed again, for example in order to bind in further sheet material or to remove sheet material. As an alternative thereto, provision can be made for the snap-lock connection to enable no further disengagement of the bridging elements.

The coupling tab(s), like the bridging piece, should also be embodied in such a way that in the assembled state, it fills up the associated recess in the sub-ring in such a way that the contour of the sub-ring continues there, i.e. the binding ring exhibits no external discontinuities in the region of the bridging element.

According to a further feature of the invention, provision is made that the binding ring(s) forms(s), on the exterior or interior, circumferential surfaces that extend perpendicular to the ring plane. If the binding ring is circular, these surfaces have a cylindrical shape. The provision of such surfaces prevents the binding ring from tipping over when the sheet material is laid on a plane.

Plastics are especially suitable as a material for the binding ring(s), since binding rings made of this material can be manufactured inexpensively, have a low weight, and cause almost no scratches, in particular when the binding ring has no sharp edges. Other materials may, of course, also be appropriate.

The binding rings are preferably embodied identically to one another. No major limitations exist with regard to their conformation. Circular binding rings are most appropriate, but the binding rings can also be shaped differently, for example as an oval, rectangle with rounded corners, etc.

As already mentioned above, the binding ring according to the present invention can be embodied in such a way that it cannot be reopened after a closing operation. This can be achieved by means of correspondingly embodied snap-lock connections. If, however, the need exists to remove sheets from the sheet material or to add further sheets to the sheet material, it is useful if the binding ring can also be opened again after a closing operation.

### BRIEF DESCRIPTION OF THE DRAWINGS

The invention is illustrated in more detail, with reference to an exemplifying embodiment, in the drawings, in which:

FIG. 1 is a perspective depiction of a binding ring, made up of a sub-ring and bridging element, in the open state;

FIG. 2 is likewise a perspective depiction of the binding ring of FIG. 1 in the closed state, but rotated approximately 180° as compared with the depiction in FIG. 1.

### DETAILED DESCRIPTION OF THE PREFERRED EMBODIMENT(S)

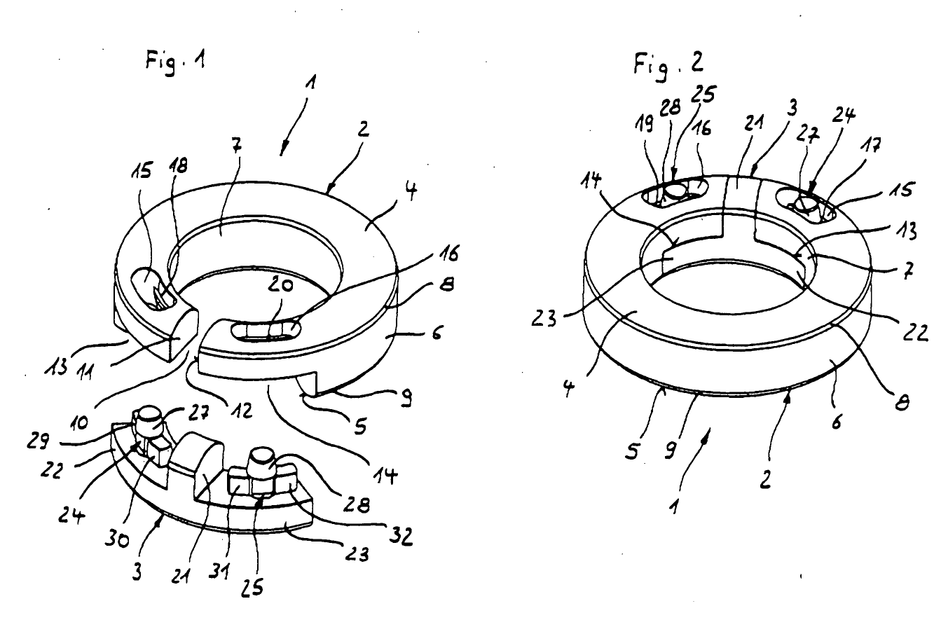

Binding ring 1 depicted in FIGS. 1 and 2 is made up of two parts, namely a sub-ring 2 and a bridging element 3. Sub-ring 2 is circular in configuration, and has a rectangular cross section having top and bottom side surfaces 4, 5 that extend parallel to the ring plane, and having internal and external cylinder surfaces 6, 7 that proceed perpendicular to the ring plane. Side surfaces 4, 5 transition into cylinder surfaces 6, 7 and are connected to one another by edges 8, 9 that form chamfers.

As is evident from FIG. 1, sub-ring 2 is not continuous but has a gap 10 that is delimited by end surfaces 11, 12 of sub-ring 2. Adjacent to gap 10, sub-ring 2 has step-shaped recesses 13, 14. In the region of recesses 13, 14, sub-ring 2 is penetrated by respective passthrough slots 15,16 that are elongated in the circumferential direction. Extending into each passthrough slot 15, 16 is a pair of snap-lock steps 17, 18 and 19, 20, configured opposite one another at the same height, that protrude into passthrough slots 15, 16.

Bridging element 3 has a T-shaped basic shape with a bridging piece 21 and with coupling tabs 22, 23 shaped onto bridging part 21 on either side. Shaped onto coupling tabs 22, 23, on the side on which bridging part 21 projects, are snap-lock pins 24, 25 that protrude upward from coupling tabs 22, 23 and constitute, at their free ends, snap-lock cones 27, 28 that taper toward the free ends. Below snap-lock cones 27, 28, snap-lock pins 24, 25 are each flanked by two shaped blocks 29, 30 and 31, 32.

In the open state, as is evident from FIG. 1, sheet material can be placed onto sub-ring 2 by inserting the sheet material through gap 10 until the hole of a perforation is located at the level of end surfaces 11, 12. Sub-ring 2 can then be rotated so that it passes through said hole. Bridging element 3 is then moved upward, out of the position shown in FIG. 1, in such a way that bridging piece 21 fits into gap 10 and coupling tabs 22, 23 fit into recesses 13, 14. In this context, snap-lock pins 24, 25 penetrate through passthrough slots 15, 16, while snap-lock cones 27, 28 slide past snap-lock steps 17, 18 and 19, 20, respectively, being laterally compressed thereby. The final position of bridging element 3 is reached when snap-lock cones 27, 28 have moved completely past snap-lock pins 17, 18 and 19, 20 and then return to their original shape. The diameter of the lower edges of snap-lock cones 27, 28 is then once again larger than the open spacing between the respectively opposite snap-lock steps 17, 18 and 19, 20, i.e. the locked-in state has been attained.

This position is shown in FIG. 2. It is particularly evident from this Figure that bridging piece 21 and coupling tabs 22, 23 are shaped in such a way that bridging piece 21 fills gap 10, and coupling tabs 22, 23 fill recesses 13, 14, in complete and flush fashion. The completed binding ring 1 has no discontinuity in the region of bridging element 3, i.e. its contour corresponds in this region to the remaining contour of sub-ring 2, i.e. binding ring 1 is circular in rotationally symmetrical fashion.

Passthrough slots 15, 16 make it possible to exert compressive force onto the free ends of snap-lock cones 27, 28 in the direction toward coupling tabs 22, 23, in order to push them downward past snap-lock steps 17, 18 and 19, 20 and thus press bridging element 3 downward out of the position shown in FIG. 2.

Binding ring 1 can thereby be reopened, for example in order to remove the sheet material from it, take out individual sheets of the sheet material, or add sheets to the sheet material. Binding ring 1 can then be closed again by way of the manipulations described above.

I claim:

1. A binding system for binding sheet material equipped with a perforation, the binding system comprising a binding ring (1) that can be brought from an open state, in which it forms a gap (10) for placing the sheet material onto the binding ring (1) into a closed state, in which the binding ring (1) does not form a gap (10),
wherein the binding ring (1) is embodied as an individual ring having no connection to a binding spine.

2. The binding system according to claim 1, wherein the binding system comprises multiple such binding rings (1) that are not connected to one another.

3. The binding system according to claim 1, wherein the binding ring(s) is/are bendable from the closed state into the open state.

4. The binding system according to claim 1, wherein the binding ring(s) has/have a respective hinge with which it/they is/are divided into ring segments that are pivotable relative to one another, via the hinge, in order to open and close the binding ring.

5. The binding system according to claim 3, wherein the binding ring(s) respectively comprise(s) in the region of the gap at least one coupling element that brings about an overlap in the closed state.

6. The binding system at least according to claim 1, wherein the binding ring (1) comprises a sub-ring (2) forming the gap (10), and a bridging element (3) capable of closing the gap (10).

7. The binding system according to claim 6, wherein the binding system comprises multiple such binding rings (1) that are not connected to one another.

8. The binding system according to claim 6, wherein in the unassembled state, the bridging element(s) is/are not connected to the associated sub-ring (2).

9. The binding system according to claim 6, wherein the bridging element(s) (3) comprise(s) a respective bridging piece (21) that is adapted to the contour of the sub-ring (2) in such a way that it fills up the gap (10) in flush fashion and continues the contour of the sub-ring (2) to yield a closed binding ring (1).

10. The binding system according to claim 6, wherein the bridging element(s) (3) comprise(s) at least one respective coupling tab (22, 23), and for each coupling tab (22, 23), a recess (13, 14) for reception of the coupling tab (22, 23) is shaped into the sub-ring(s) (2), in each case adjacent to the gap (10.

11. The binding system according to claim 10, wherein the bridging element(s) (3) respectively comprise coupling tabs (22, 23) on either side of the bridging piece (21), and recesses (13, 14) for overlapping reception of the coupling tabs (22, 23) are respectively shaped into the sub-ring(s) (2) on either side of the gap (10).

12. The binding system according to claim 10, wherein the coupling tab(s) (22, 23) is/are connectable to the associated sub-ring (2) via a respective snap-lock connection.

13. The binding system according to claim 10, wherein in the assembled state, the coupling tab(s) (22, 23) fill(s) up the recesses (13,14) in such a way that the contour of the respective sub-ring (2) continues there.

14. The binding system according to claim 1, wherein the binding ring(s) (1) forms(s), on the exterior, a circumferential surface (6) that extends perpendicular to the ring plane.

15. The binding system according to claim 1, wherein the binding ring(s) (1) forms(s), on the interior, a circumferential surface (7) that extends perpendicular to the ring plane.

16. The binding system according to claim 1, wherein the binding ring(s) (1) is/are made of plastic.

17. The binding system according to claim 1, wherein the binding rings (1) are embodied identically to one another.

18. The binding system according to claim 1 wherein the binding ring(s) (1) is/are circular.

19. The binding system according to claim 1, wherein the binding ring(s) (1) is/are also re-openable after a closing operation.
